(19) United States
(12) Patent Application Publication
(10) Pub. No.: US 2024/0273103 A1
(43) Pub. Date: Aug. 15, 2024

(54) System and Methods for Invoking Pattern Matching to Query Tabular Data Collections

(71) Applicant: Michael Seul, Basking Ridge, NJ (US)

(72) Inventor: Michael Seul, Basking Ridge, NJ (US)

(21) Appl. No.: 18/440,694

(22) Filed: Feb. 13, 2024

Related U.S. Application Data
(63) Continuation-in-part of application No. 18/108,413, filed on Feb. 10, 2023.

(51) Int. Cl. G06F 16/2455; G06F 16/2453; G06F 16/248

(52) U.S. Cl. CPC G06F 16/2456; G06F 16/24537; G06F 16/24544; G06F 16/248

(57) ABSTRACT

Disclosed is a method for querying by pattern matching a relational data store, including a collection of records having a preset number of attributes, wherein the representation of the content of a structured or unstructured data source also encodes the structure of the data source, and including these steps:
providing at least one query comprising at least a find- and a where-clause, wherein the where-clause comprises one or more query patterns, and the find-clause specifies a subset of attributes optionally including aliases thereof; executing the query by:
   applying predicates in the one or more query patterns to identify a subset of matching or non-matching records;
   forming the intersection of the two or more subsets of records for two or more patterns;
   in accordance with the find-clause, selecting specified attributes and applying any aliases; and
      thereby identifying the subset of records satisfying constraints expressed in the query patterns.

### BACKGROUND

The Standard Query Language (‘SQL’) remains to date the most widely used query language for relational databases. However, applications invoking SQL, in any of its common dialects, must include a special interface to the requisite relational database management software. Nor does the SQL syntax, especially for recursive queries, represent a model of transparency.

An alternative, introduced in the context of logic programming (REF: “Structure and Interpretation of Computer Programs”, Abelson & Sussman, 2nd Edition, The MIT Press, Cambridge, MA 1996, Chapter 4.4), is pattern matching. To query a collection of data (‘facts’), constituent tuples are compared to congruent query patterns; thus, for data in Entity-Attribute-Value (or ‘E-A-V’) format, triples are compared to a pattern such as (?x c ?y), and upon finding a matching triple (or ‘datum’) in the collection, the pattern variables ?x and ?y are bound to the corresponding values of that datum. Proceeding in this way, a collection of matching tuples is created (which may be empty). Simple queries may be combined by way of the logical operators AND, OR and NOT to form compound queries. Further, queries may be abstracted by introducing rules, in the form (rule <head> <body>) wherein head (or ‘conclusion’) is a pattern, and body (or ‘premise’) is any query; rule definitions may be recursive, such that a term or variable appears in the conclusion as well as the premise. A rule represents (the analog of) a logical implication, wherein a variable binding that satisfies the premise also satisfies the conclusion. Facts may be regarded as rules without body. The inclusion of rules in the data store permits the deductive retrieval of facts from the collection, as in Datalog.

What is desirable is a query language that invokes the concept of pattern matching to query relational data stores, in a tabular format having a preset number of named attributes, in wide or narrow representation (REF—en.wikipedia.org web site under/wiki/Wide_and_narrow_data), wherein queries have the form of objects in the chosen implementation language. Eliminating dependencies on SQL or other special query languages and instead embedding queries natively in applications has the benefit of simplification and transparency, especially for lightweight applications, including but not limited to applications intended for mobile devices.

Especially desirable is the use of pattern matching to query data stores in GenericTabularRepresentation (‘gtr’), including but not limited to the implementation of chained self-joins, for aggregating selected content for presentation in a condensed tabular format, and relationship primitives, for navigating this representation, in a manner analogous to XPath Axes REF—developer.mozilla.org web site, under en-US/docs and further under/Web/XPath/Axes.

### SUMMARY

Disclosed herein are a system and methods for querying relational data collections by matching records in the collection to query patterns specifying PredicateExpressions, the system and methods of the invention obviating the need for SQL and related query languages. The system of the invention comprises an Interpreter, preferably a JavaScript program, that executes queries provided in the form of objects in the language of the Interpreter, preferably JavaScript objects. The Interpreter also performs additional operations, including but not limited to executing a JOIN operation to combine the outputs returned by two or more queries executed in sequence. The invention comprises methods for creating, evaluating, transforming and executing queries.

In one respect, the system and methods of the invention enable the implementation of fundamental types of queries directed to the GenericTabularRepresentation for transforming and navigating said representation.

### BRIEF DESCRIPTION OF THE FIGURES

FIG. 1 is a data flow diagram, in the form of a bi-partite graph, for execution of a query comprising multiple clauses such as find-, where- and in-clauses and variants of where-clause, as described herein; in the diagram, rectangles represent actions, ellipses represent input and output objects.

FIG. 2 is a data flow diagram for chaining of record sets arr_1, produced by a first query, and arr_2, produced by a second query, on a PredicateExpression—relating to Example E.1.

FIG. 3 is a depiction of a web form for collecting query input and submitting the assembled query for execution.

### BRIEF DESCRIPTION OF SOME OF THE TABLES

Table 1—Section of table in wide GenericTabularRepresentation generated from a primary JSON source; the table has seven columns, but is here displayed in split format given limited space—relating to Section 1 of the Specification & Example E.1,

Table 2—Principal constraints defining RelationshipPrimitives with reference to a given context node object, here denoted ‘cn’.

Table E.1.1—Tabular output returned by the SQL Query, labeled E1.1 in Example 1, directed to the data collection of Table 1—relating to Example 1.

Table E.2.1—Section of a table in wide GenericTabularRepresentation, generated from the HTML source of the National Cancer Institute Page www.cancer.gov/about-cancer for Approved Targeted Therapies under/treatment/types and further/targeted-therapies/approved-drug-list; compared to Table 1, this table comprises the additional columns Level (as defined), SourceId, for recording a reference to the primary data source, and Timestamp, for recording the time of creation of the table as a Current Epoch UNIX Timestamp; the table is displayed in split format given limited space—relating to Section 2 of the Specification & Example E.2.

Table E.2.1.1—Context node attribute record—relating to Example E.2.

Table E.2.1.2—Context node record—relating to Example E.2.

### DETAILED DESCRIPTION

It is to be understood that both the foregoing general description and the following detailed description are exemplary and explanatory and are intended to provide further explanation of the invention as claimed.

Unless otherwise defined, all technical and scientific terms used herein have the same meaning as commonly understood by one of ordinary skill in the art to which this invention belongs. Still, certain elements are defined for the sake of clarity and ease of reference.

### Definitions

The following terms are used herein as follows:
JavaScript, also simply ‘JS’, unless otherwise indicated, herein refers to modern ECMAScript vs 6 or higher, as described at REF—webpage 262.ecma-international.org under ‘/6.0/’;
Key:Value Pair Syntax is a notation for assigning a value to a key, as in JavaScript Object Notation (‘JSON’) and in related data structures such as a JavaScript Map or a Python dictionary;
Path or NodePath is a key in a flattened representation of a nested object, in the form of string comprising the preferably dot-separated sequence of nodes traversed, from the root, to reach a specific node in the tree representing the original nested object;
Path-Encoded, as in path-encoded object, refers to an object whose keys are in the form of paths;
FunctionExpression is a string, a templated string or a template literal representing a JavaScript anonymous arrow function; for simplicity, the term ‘expression’ is applied herein to the actual expression as well as its representation;
PredicateExpression is a string, which may be templated, that is, comprise a substitution variable, or may be a JavaScript template literal or equivalent comprising one or more predicates REF—en.wikipedia.org web site under/wiki/Predicate (mathematical logic), conforming to the syntax of an anonymous function expression; for simplicity, the term ‘expression’ is applied herein to the actual expression as well as its representation;
RelationalDataTable or RelationalTable or RelationalDataStore is a tabular collection of items of information (‘data’) in which relations between items of information are explicitly specified in the form of named attributes REF—en.wikipedia.org web site under/wiki/Relational_database; and
GenericTabularRepresentation (REF—U.S. application Ser. No. 18/108,413 entitled ‘A Universal Container for Structured and Unstructured Data from Disparate Sources, and Methods for Querying Same’, priority to which is claimed) is a tabular representation of source content of disparate format and type with a preset number of named attributes, in wide (‘w-gtr’ or simply ‘gtr’) or narrow (‘n-gtr’) format; the gtr encodes the hierarchical source structure of primary source documents by relative and absolute paths, wherein relative paths are represented by pairs of recordNo, an integer numbering records, and parentRecordNo, an integer representing, for any record, the recordNo of the immediately preceding node, and absolute paths are represented by a uniquePropertyPath (‘uPP’), a string of dot-separated elements of the form level-recordNo, such as ‘0-0.1-3.2-188.3-196.4-221.5-3919.6-3924.7-3983.8-4763.9-4775.10-4777’, wherein level is an integer representing the depth of a specific node within the hierarchy, and wherein the root is at level 0.

### 0—Utility

In one respect, the present invention discloses methods for querying tabular data stores by pattern matching, as an alternative to invoking SQL or other special query languages. In another respect, the present invention discloses methods for forming, instantiating, transforming and executing such queries natively, within an application.

In preferred embodiments, methods of the invention apply to RelationalDataStores, containing data in wide tabular representation comprising a preset number of named attributes (‘columns’), including the GenericTabularRepresentation for hierarchically structured (also herein ‘nested’) and unstructured data from sources of disparate type and format. Queries for navigating and transforming the GenericTabularRepresentation, with and without recursion, are disclosed and illustrated herein. The methods herein disclosed extend the utility of the GenericTabularRepresentation by providing a non-SQL query interface.

### 1—Constructing and Executing Queries

The Query Object—In a preferred embodiment, a query of the invention is an object in the language of the query Interpreter; in a preferred embodiment, wherein the Interpreter is a JavaScript program, this object is a JavaScript object; in alternative embodiments, a query may be represented as an alternative data structure having key-value pairs, or equivalent, including but not limited to the JavaScript Map, which also provides additional methods REF—developer.mozilla.org web site under/en-US/docs/Web/JavaScript/Reference and further under/Global_Objects/Map. The term object, as used herein, covers all such alternatives, as appropriate.

The query object comprises clauses, in the form of key-value pairs (or equivalent), namely at least a find-clause, and, unless the entire data collection is to be returned, a where-clause. In a preferred embodiment, wherein the Interpreter is a JavaScript program, clauses comprise a key identifying the clause and a value comprising strings REF—‘Datalog in Javascript’ Stepan Parunashvili, Apr. 25, 2022 www.instantdb.com web site under/essays/datalogjs, namely strings or arrays of strings or, as disclosed herein, arrays of objects comprising strings, wherein strings with a leading “?” reference attributes of the data collection; such strings are herein also referred to as variables, but are to be distinguished from variables in traditional pattern matching.

The find-clause comprises the key find and a value in the form of an array of variables identifying attributes to be included in the query output, wherein the special variable “?*”, indicates the selection of all attributes.

The where-clause comprises the key where and a value in the form of an array of objects, wherein, as disclosed and illustrated herein, each such object represents a query pattern in the form of a key-value pair whose key is a variable, as in “?gtrAttributeName”, and whose value is a PredicateExpression to be applied to the content of the table column identified by the key; this structure differs from that of patterns in classic pattern matching, which is an array that conforms to the tuple structure of the data collection.

A query of the invention optionally may comprise an in-clause and variants of the where-clause, as a group referred to herein as where-clauses, the group including at least a whereFurther-, a whereNext- and a recursive whereNext-clause, as well as other clauses, described in greater detail below.

Patterns as Constraints—In accordance with the present invention, patterns represent constraints, in the form of predicates or PredicateExpressions, that are applied by filtering the data collection so as to select (or reject) sets of matching records, if any. Accordingly, a matching record herein means a record satisfying a constraint, that is: a record for which predicates in the corresponding query pattern evaluate to ‘true’.

In one embodiment, functions referenced in PredicateExpressions, including but not limited to isEQ, isPref, incr and decr, as invoked in illustrative queries herein, including in Examples, are pre-defined in the Interpreter; in a preferred embodiment, additional functions are defined within applications and bound to global variables to make them accessible to the Interpreter.

Queries comprising two or more patterns are executed by applying each pattern in turn, then combining the resulting two or more record sets by conjunction, corresponding to the logical AND operator, herein the default operation, or disjunction, corresponding to logical OR operator. When querying a relational data store, including w-gtr, all matching records have the same structure, and combining comprises, for conjunction, the intersection and, for disjunction, the union of the two or more tuple sets, as illustrated herein below.

This is in contrast to an embodiment wherein the tuple sets generated by applying constraints to a data collection in Entity-Attribute-Value (‘E-A-V’) or a related generic information format are JOIN-ed pairwise on a shared variable, preferably recursively, after arranging a sequence of patterns so as to ensure that sets generated by application of adjacent patterns share a variable on which to execute the JOIN.

Creating the Query Object—As disclosed and illustrated herein, a query object may be defined as an object literal; or may be created by invoking an object constructor; or may be provided as a JSON file or API payload; alternatively, a query object may be created dynamically within an application, as disclosed and illustrated herein.

Executing Queries—Queries are executed by an Interpreter, herein a JavaScript program. An Interpreter of the query language of the present invention also may be implemented in other programming languages supporting objects (or equivalent data structures) and a functionality for evaluating strings to produce valid expressions, notably in one of several modern versions of LISP such as Clojure.

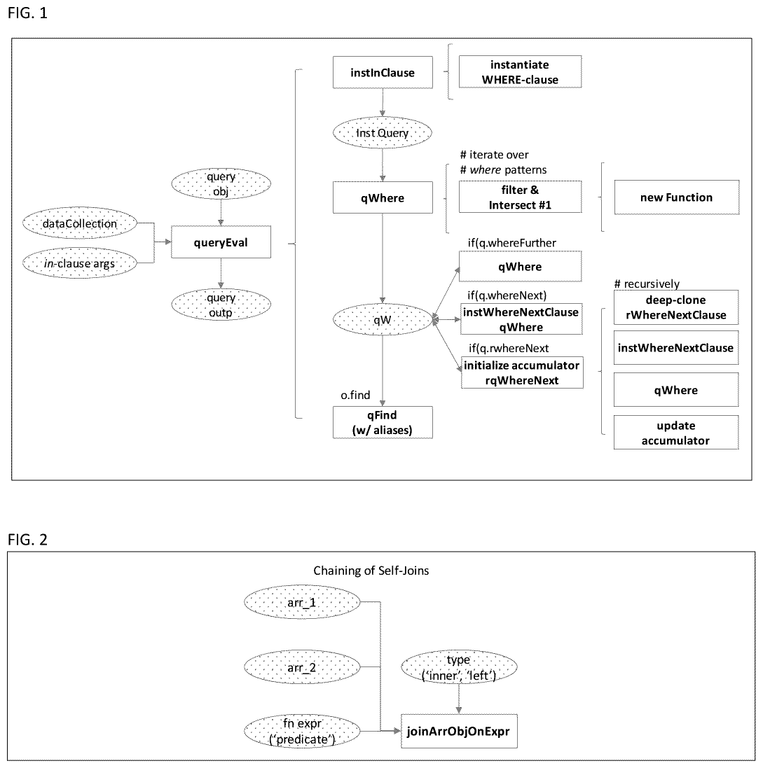

To execute a query, the query object is provided, as one argument, to a query evaluating and executing function of the Interpreter (‘QueryEvaluator’), along with further arguments comprising at least the name of the data collection of interest, and where appropriate an argument for instantiating parametrized queries, as disclosed and illustrated herein. The dataflow for processing a query in accordance with the system and methods of the invention is shown in FIG. 1.

1.1 Simple Queries: Find- and where-Clauses

Table 1 shows a section of a larger w-gtr table (of 3,383 records) having seven attributes, generated from a nested JSON file reporting the results of a genomic scan of a sample from an oncology patient, including information on several mutations.

TABLE 1

| recordNo | parentRcNo | leaf | uniquePropPath |
|---|---|---|---|
| 46404 | 46402 | 1 | 0-0.1-5.2-46399.3-46401.4-46402.5-46404 |
| 46405 | 46404 | 1 | 0-0.1-5.2-46399.3-46401.4-46402.5-46404.6-46405 |
| 46406 | 46405 | 1 | 0-0.1-5.2-46399.3-46401.4-46402.5-46404.6-46405.7-46406 |
| 46407 | 46406 | 0 | 0-0.1-5.2-46399.3-46401.4-46402.5-46404.6-46405.7-46406.8-46407 |
| 46408 | 46406 | 1 | 0-0.1-5.2-46399.3-46401.4-46402.5-46404.6-46405.7-46406.8-46408 |
| 46409 | 46408 | 0 | 0-0.1-5.2-46399.3-46401.4-46402.5-46404.6-46405.7-46406.8-46408.9-46409 |
| 46410 | 46408 | 0 | 0-0.1-5.2-46399.3-46401.4-46402.5-46404.6-46405.7-46406.8-46408.9-46410 |
| 46411 | 46408 | 0 | 0-0.1-5.2-46399.3-46401.4-46402.5-46404.6-46405.7-46406.8-46408.9-46411 |
| 46412 | 46406 | 0 | 0-0.1-5.2-46399.3-46401.4-46402.5-46404.6-46405.7-46406.8-46412 |
| 46413 | 46406 | 0 | 0-0.1-5.2-46399.3-46401.4-46402.5-46404.6-46405.7-46406.8-46413 |
| 46414 | 46406 | 0 | 0-0.1-5.2-46399.3-46401.4-46402.5-46404.6-46405.7-46406.8-46414 |
| 46415 | 46406 | 0 | 0-0.1-5.2-46399.3-46401.4-46402.5-46404.6-46405.7-46406.8-46415 |

| propPath | propKey | propVal |
|---|---|---|
| content[12].content[0].hgvsNomenclature | hgvsNomenclature | (null) |
| content[12].content[0].hgvsNomenclature.cSyntaxes | cSyntaxes | (null) |
| content[12].content[0].hgvsNomenclature.cSyntaxes[0] | 0 | (null) |
| content[12].content[0].hgvsNomenclature.cSyntaxes[0].consequence | consequence | non_synonymous |
| content[12].content[0].hgvsNomenclature.cSyntaxes[0].gene | gene | (null) |
| content[12].content[0].hgvsNomenclature.cSyntaxes[0].gene.symbol | symbol | MSH2 |
| content[12].content[0].hgvsNomenclature.cSyntaxes[0].gene.identifier | identifier | 4436 |
| content[12].content[0].hgvsNomenclature.cSyntaxes[0].gene.cytogenicLocation | cytogenicLocation | 2p21 |
| content[12].content[0].hgvsNomenclature.cSyntaxes[0].pSyntax | pSyntax | NP_000242.1: p.N596* |
| content[12].content[0].hgvsNomenclature.cSyntaxes[0].source | source | refseq |
| content[12].content[0].hgvsNomenclature.cSyntaxes[0].transcSyntax | transcSyntax | NM_000251.2: c.1786_1787delAA |
| content[12].content[0].hgvsNomenclature.cSyntaxes[0].chromcSyntax | chromcSyntax | chr2(NM_000251.2): c.1786_1787delAA |

The following simple query illustrates the structure of each clause, in the form of a key-value pair, wherein value, for the find-clause, is an array of strings, each string comprising a variable referring to an attribute while also specifying an (optional) alias, indicated by the infix ‘_AS_’; and, for the where-clause, is an array of objects, the array here comprising a single query pattern having a key that identifies an attribute in Table 1, and a value comprising a PredicateExpression; prior to evaluating this expression, the Interpreter substitutes for the variable x, the variable specified in the pattern key, here x.propPath.

In accordance with the where-clause, the query retrieves records that include the symbols of mutated genes, and, in accordance with the find-clause, reports the symbols of any such genes along with the corresponding uniquePropPath.

Query 1.1.1

```
let qGTR = {
  find: [“?propVal_AS_geneSymbol”,“?uniquePropPath_AS_uPP”],
  where: [
    {“?propPath”:“(x) => x.includes(‘cSyntaxes[0].gene.symbol’)”}
  ]
}
```

The query is executed by invoking a query evaluating and executing function (‘QueryEvaluator’), here named queryEval or simply query, with arguments comprising: the name of the query object, for example qGTR and the name of the data collection of interest, for example gtrTb, thus query(qGTR, gtrTb). With Query 1.1.1, this function returns a set of 19 records (of which only the first and last several are shown):

```
[
  {
    geneId: ‘TERT’,
    uPP: ‘.0-0.1-5.2-21.3-23.4-24.5-26.6-28.7-29.8-30.9-32.10-33’
  },
  {
    geneId: ‘TP53’,
    uPP: ‘.0-0.1-5.2-21.3-23.4-5010.5-5012.6-5014.7-5015.8-5016.9-5018.10-5019’
  },
      ...
  {
    geneId: ‘ERBB2’,
    uPP: ‘.0-0.1-5.2-46399.3-46401.4-162742.5-162744.6-162745.7-162746.8-162748.9-162749’
  },
  {
    geneId: ‘GNAS’,
    uPP: ‘.0-0.1-5.2-46399.3-46401.4-163330.5-163332.6-163333.7-163334.8-163336.9-163337’
  }
]
```

To constrain the returned record set, for example to a specific known gene symbol, if present in the data set, a suitable constraint is added in the form of a second query pattern, as in:

Query 1.1.2

```
qGTR = {
  find: [“?propVal_AS_geneId”,“?uniquePropPath_AS_uPP”],
  where: [
    {“?propPath”:“(x) => x.includes(‘cSyntaxes[0].gene.symbol’)”},
    {“?propVal”:“(x) === ‘TP53’]”}
  ]
}
```

to obtain:

```
[
  {
    geneId: ‘TP53’,
    uPP: ‘.0-0.1-5.2-21.3-23.4-5010.5-5012.6-5014.7-5015.8-5016.9-5018.10-5019’
  },
  {
    geneId: ‘TP53’,
    uPP: ‘.0-0.1-5.2-21.3-23.4-22178.5-22180.6-22181.7-22182.8-22183.9-22185.10-22186’
  },
  {
    geneId: ‘TP53’,
    uPP: ‘.0-0.1-5.2-46399.3-46401.4-108048.5-108049.6-108050.7-108051.8-108053.9-108054’
  },
  {
    geneId: ‘TP53’,
    uPP: ‘.0-0.1-5.2-46399.3-46401.4-122971.5-122973.6-122974.7-122975.8-122977.9-122978’
  }
]
```

This record set represents the intersection of the sets returned by applying, serially, the constraints in the two query patterns, reflecting the conjunction of the two patterns; additional patterns may be inserted, as desirable, in any order.

To enhance its expressiveness, the query language of the invention supports queries having additional clauses.

Execution Efficiency—In one respect, a whereFurther-clause provides a means of improving execution efficiency, by reducing the number of filtering operations, wherein patterns in a whereFurther-clause represent supplemental constraints to be applied only to record sets returned by execution of a where-clause; this is illustrated in Example 1.

Additional clauses are introduced in the context of devising parametrized queries, though they are not thereby limited to that use case.

### 1.2 Parametrized Queries

To further enhance the functionality and utility of the query language, the methods of the present invention further support parametrized queries.

### 1.2.1 In-Clause

In one embodiment, parametrization comprises introducing into the query object an in-clause to provide a uniform interface for conveying information to the query object. The in-clause value is a string, or an array of strings comprising strings representing variables, matching variables in one of the query patterns (REF—Datomic Datalog, learndatalogtoday.org website); these variables are instantiated by substituting values provided as additional arguments to the QueryEvaluator, for example “?geneSymbols” in the following query:

Query 1.2.1

```
let pqGTR = {
  find: [“?propVal_AS_GeneSymbol”,“?uniquePropPath”],
  in: “?geneSymbols”,
  where: [
    {“?propKey”:“(x) => x === ‘symbol’”},
    {“?propVal”:“?geneSymbols”},
    {“?propPath”:“(x) => x.includes(‘cSyntaxes[0]’)”}
  ]
}
```

Accordingly, invoking the QueryEvaluator with Query 1.2.1, the name of the data store, for example ‘gtrTb’, and an additional argument, for example geneSymbols=‘TP53’, thus query(pqGTR, gtrTb, geneSymbols), reproduces the output of Query 1.1.2, in this Section, above. In accordance with the dataflow diagram of FIG. 1, the argument geneSymbols is substituted for the value of the in-clause, “?geneSymbols”, and this in turn replaces the matching variable in the where-clause. In a preferred embodiment, the Interpreter applies the instantiated constraint using the default predicate ‘is equal’, or ‘===’ (which also may be explicitly specified, as in the example of the first pattern).

More generally, as with the SQL IN clause, the in-clause accommodates a list of arguments. Thus, to extract information for a pair of genes, the parametrized Query 1.2.1 is executed by invoking the QueryEvaluator with an additional argument in the form of an array, for example geneSymbols=[′TP53′, ‘MSH2’], whereupon query(qpGTR, gtrTb, geneSymbols), returns a record set representing the union of the record sets produced by iterating the query over the individual elements of geneSymbols. In a preferred embodiment, the Interpreter applies an instantiated constraint comprising an array of values using the default predicate ‘array.includes(x)’, that is, in this example, {“?propVal”:“?geneSymbols”}, after instantiation, expands to {“?propVal”:“(x)=>[′TP53′, ‘MSH2’].includes(x)”}.

Optionally, the Interpreter also accommodates a variant of the in-clause syntax, in: “[ . . . ? geneSymbols]”, providing a mnemonic device that recalls the JavaScript destructuring assignment to indicate that arguments to the QueryEvaluator are expected in the form of an array.

In a preferred embodiment, the in-clause accommodates PredicateExpressions, provided as arguments to the QueryEvaluator, thereby significantly expanding the functionality of the query language of the invention. For example, to extract information for all genes with symbols containing the letter ‘T’, the parametrized Query 1.2.1 may be executed by invoking the QueryEvaluator with geneSymbols=“(x)=>x.includes(‘T’)” to return a record set of 10 records, in the format above, comprising entries for the gene symbols ‘TERT’, ‘TP53’, ‘TSC1’, ‘ATM’, ‘TSC2’.

1.2.2 where-Clauses

In addition to the where- and whereFurther-clauses, queries may have additional variants of where-clauses, including but not limited to a non-recursive or a recursive whereNext-clause.

Other-Referencing and Self-Referencing Queries—In one respect, where-clauses comprising PredicateExpressions provide a means of referencing second objects, defined or created external to the query object, as well as record sets created by applying constraints in preceding clauses of the query.

A query of the former type, also referred to herein as ‘other-referencing’, preferably comprises a where- or a whereFurther-clause having at least one pattern comprising a PredicateExpression in the form of a template literal that references an object previously defined or created.

A query of the latter type, also referred to herein as ‘self-referencing’, preferably comprises a whereNext-clause having at least one pattern comprising a parametrized PredicateExpression, wherein, prior to executing that clause, constituent substitution variables are instantiated, by referencing values in record sets returned by executing a preceding where- or whereFurther clause. Self-referencing queries provide an alternative means of devising and executing a sequence of separate queries enabling a more compact and transparent query design.

Recursive Queries—Self-referencing queries may be recursive. In lieu of the whereNext-clause of a self-referencing query, a recursive query comprises an rwhereNext-clause to reference the tuple set returned by executing the preceding where-clause, or the record set returned by a previous instantiation of the rwhereNext-clause itself; self-referencing and recursive queries are illustrated in Example E.2.

### 1.2.3 Method-Clause

Object further may have a method clause. In one respect, a method clause comprises a means for accessing the record set returned by executing a preceding clause. In one embodiment, the the method clause comprises a function expression specifying an aggregate function to be applied to the record set returned by the preceding clause specified in the clause. For example, the method clause:

$$method : [ \{ “ ? where ” : “ ( x ) \text{=>} count ( x \} ” \}$$

causes the Interpreter to display the number of records returned by the preceding where-clause. In other respects, the method clause provides the means for implementing additional aggregate functions such as min, max, average and sum, or other transformations.

### 1.3 Compound Queries

Combining Simple Queries—In one embodiment, compound queries are formed by combining individual query patterns by way of the logical operators AND (‘conjunction’), OR (‘disjunction’) and NOT (‘negation’), wherein the query output is obtained by forming the intersection, the union and or the complement, respectively, of the record set(s) returned by applying individual patterns. Preferably, and by default herein, query patterns are combined by conjunction.

To accommodate the logical operators, the syntax of the query object may be expanded, as in the following.

Query 1.3.1

```
let pqGTR = {
  find: [“?propVal_AS_GeneSymbol”,“?uniquePropPath”],
  in: “?geneSymbols”,
    where: [{
      “” : {“?propKey”:“(x) => x === ‘symbol’”},
      “AND” : {“?propVal”:“?geneSymbols”},
      “OR” : {“?propPath”:“(x) => x.includes(‘cSyntaxes[0]’)”}
    }]
}
```

Compound Queries by PredicateExpression—In one respect, PredicateExpressions provide the preferred means for devising compound queries.

For example, the record set of 10 records returned by Query 1.2.1, in the preceding sub-section, with the PredicateExpression “(x)=>x.includes(‘T’)” may be expanded by including information such that ‘propKey’ may satisfy one of several constraints, in a manner equivalent to combining individual constraints by the OR operator. This is illustrated by the following query, wherein the pattern {“?propKey”:“(x)=>x===‘symbol’”} is replaced by {“?propKey”:“(x)=>[‘symbol’, ‘identifier’].includes(x)”}.

Query 1.3.2

```
qpGTR = {
  find: [“?propVal_AS_GeneSymbol/-Identifier”,“?uniquePropPath”],
  in: “?geneSymbols”,
  where: [
    {“?propKey”:“(x) => [‘symbol’,‘identifier’].includes(x)”},
    {“?propVal”:“?geneSymbols”},
    {“?propPath”:“(x) => x.includes(‘cSyntaxes[0]’)”}
  ]
}
```

For example, execution with geneSymbols=“(x)=>x.includes(‘T’)| | (6000<x && x<7200)”, returns the union of the record sets returned by executing the query with only the first and only the second condition in the PredicateExpression, where (with reference to Table 1) the first condition specifies values of propVal with propKey equal to symbol and the second condition sets the range of acceptable values of propVal with propKey equal to identifier.

### 1.4 Dynamic Queries

In one embodiment, queries are formed and transformed programmatically by JavaScript functions for manipulating objects. In a preferred embodiment, a set of functions to this end includes, but is not limited to:

1.4.1 Creating a Minimal Query Object Comprising Find and where Clauses

```
const newQuery = ( ) => {
  let q = new Object( );
  q.find = [“?*”];
  q.where = [[“?attributeNm”,“?value”]];
  return q;
};
//Usage:
let qGTR = newQuery( );
```

### 1.4.2 Appending a Clause

```
const appendClause = (q, key, val) => {
  q[key] = val;
  return q;
}
//Usage:
let qGTR = appendClause(qGTR,“whereFurther”,“?value”);
```

### 1.4.3 Inserting Clauses at Specific Positions

```
const insertClause = (q, key, val, after=”) => {
  if(after.length === 0) {
    q[key] = val;
    return q
  } else {
    let ix = Object.keys(q).findIndex(key => key === after);
    let oe = Object.entries(q);
    oe.splice(ix+1, 0, [key,val]);
    return Object.fromEntries(oe);
  }
}
//Usage:
let pqGTR = newQuery( )
pqGTR = insertClause(qGTR,“in”,“?value”,“find”); // insert after ‘find’ clause
pqGTR = insertClause(pqGTR,“whereFurther”, [[“?attributeNm”,“value”]]);
//Outp:
{
  find: [ ‘?*’ ],
  in: ‘?varName’,
  where: [ [ ‘?attributeNm, ‘value’ ] ],
  whereFurther: [ [ ‘?attributeNm’, ‘value’ ] ]
}
```

The integration of these operations into native applications further enhances the utility of the methods of the invention.

### 2—Transforming & Navigating the Generic Tabular Representation

### 2.1 Chained Self-Joins

An essential transformation of the GenericTabularRepresentation is that of aggregating selected content in a tabular format having user-selected columns. In a preferred embodiment, this is achieved by executing a sequence of individual queries, each directed to a specific variable of interest, and JOIN-ing the record sets returned by successive queries. Such a sequence for implementing the equivalent of chained self-joins, applied to Table 1, is illustrated in Example E.1. In further embodiments, the self-join operation is generalized to combine record sets returned by queries directed to different tables.

### 2.2 Relationship Primitives

RelationshipPrimitives provide a fundamental set of relations for navigating the GenericTabularRepresentation of a hierarchically structured original data source with reference to a pre-selected context node, in analogy to XPath axes, defined at REF—developer.mozilla.org web site under/en-US/docs/Web/XPath/Axes.

In one embodiment, query objects for the set of RelationshipPrimitives are constructed using the where-clause patterns in Table 2 (wherein supplemental constraints, such as those further described in Example E.2, are omitted for clarity). In other embodiments, as illustrated herein, query patterns may reference the selected context node by way of an instantiated in-clause.

TABLE 2

| Relationship | |
|---|---|
| Primitive | Function Expressions for Query Patterns |
| Self | const inClauseArg_Self = [ |
| | \grave{ }(x) => isEQ(x,′${cn.uniquePropPath}′)\grave{ } |
| | ]; |
| AncestorOrSelf | const inClauseArg_AncSelf = [ |
| | \grave{ }(x) => isPref(x,′${cn.uniquePropPath}′)\grave{ }, // Ancestor |
| | \grave{ }(x) => Number(x) <= ${cn.level}\grave{ } |
| | ]; |
| DescendantOrSelf | const inClauseArg_DescSelf = [ |
| | \grave{ }(x) => isPref(′${cn.uniquePropPath}′,x)\grave{ }, // Descendant |
| | \grave{ }(x) => Number(x) > = ${cn.level}\grave{ } |
| | ]; |
| Ancestor | const inClauseArg_Anc = [ |
| | \grave{ }(x) => isPref(x,′${cn.uniquePropPath}′)\grave{ }, // Ancestor |
| | \grave{ }(x) => Number(x) < ${cn.level}\grave{ } // exclude Self |
| | ]; |
| Descendant | const inClauseArg_Desc = [ |
| | \grave{ }(x) => isPref(′${cn.uniquePropPath}′,x)\grave{ }, // Descendant |
| | \grave{ }(x) => Number(x) > ${cn.level}\grave{ } // exclude Self |
| | ]; |
| Parent | const inClauseArg_Parent = [ |
| | \grave{ }(x) => isPref(x,′${cn.uniquePropPath}′)\grave{ }, // Descendant |
| | \grave{ }(x) => Number(x) = ${cn.level} − 1\grave{ } // |
| | ]; |
| Child | const inClauseArg_Child = [ |
| | \grave{ }(x) => isPref(′${cn.uniquePropPath}′,x)\grave{ }, // Descendant |
| | \grave{ }(x) => Number(x) = ${cn.level} + 1\grave{ } // |
| | ]; |
| Preceding | const inClauseArg_Prec = [ |
| | \grave{ }(x) => !isPref(x,′${cn.uniquePropPath}′)\grave{ }, // NOT Ancestor |
| | \grave{ }(x) => Number(x) < ${cn.recordNo}\grave{ } |
| | ]; |
| Following | const inClauseArg_Follw = [ |
| | \grave{ }(x) => !isPref(′${cn.uniquePropPath}′,x)\grave{ }, // NOT Ancestor |
| | \grave{ }(x) => Number(x) > ${cn.recordNo}\grave{ } |
| | ]; |
| PrecedingSibling | const q inClauseArg_PrecSib = [ |
| | \grave{ }(x) => x === ′${cn.parentRecordNo}′\grave{ }, // same parent |
| | \grave{ }(x) => Number(x) < ${cn.recordNo}\grave{ } |
| | ]; |
| FollowingSibling | const inClauseArg_FollwSib = [ |
| | \grave{ }(x) => x === ′${cn.parentRecordNo}′\grave{ }, // same parent |
| | \grave{ }(x) => Number(x) > ${cn.recordNo}\grave{ } |
| | ]; |

### 2.3 Named Pattern Groups

In one respect, the present invention discloses named groups of query patterns as a means for devising generalized parametrized queries, thereby further improving re-usability. For example, a grouping of the pattern combination in Query E2.2, for selecting the Ancestor set of a pre-selected context node (here denoted ‘cn’), may be named by a special key value-pair such as {“?”:“% rpExpr”}, wherein the special symbol ‘%’ indicates to the Interpreter to perform the requisite syntax expansion, as follows:

```
const rpAnc = [
  {″?″:″%rpExpr″}
  {″?uniquePropPath″:‘(x) => isPref(x,′${cn.uniquePropPath}′)‘},
  {″?level″:‘(x) => Number(x) < ${cn.level}‘}
];
```

### Similarly, for PrecedingSibling:

```
const rpPSib = [
  {″?″:″%rpExpr″},
  {″?parentRecordNo″:‘(x) => x === ′${cn.parentRecordNo}′‘},
  {″?recordNo″:‘(x) => Number(x) < ${cn.recordNo}‘}
];
```

In one respect, this array of objects is the analog of a (non-recursive) rule, wherein the first element represents (the analog of) the rule head, and the subsequent elements represent (the analog of) the rule body.

In a preferred embodiment, the complete set of RelationshipPrimitives is implemented by executing the single parametrized Query 2.3.1, providing to the QueryEvaluator the named pattern group of interest, from Table 2, as an argument to the in-clause.

Query 2.3.1

```
let prqGTR = {
  find: [“?recordNo”,“?parentRecordNo”,“?uniquePropPath”,“?propKey”],
  in: “%rpExpr”,
  where: [
    {“?”:“%rpExpr”}
  ]
}
```

Execution of this query proceeds by: first, instantiating the in-clause, namely by instantiating ‘% rpExpr’; and next, instantiating the where-clause with reference to the instantiated in-clause.

### 2.4 Inferential Information Retrieval

The methods of the present invention provide the means of retrieving information in accordance with relations defined by the analog of rules.

### 2.4.1 Defined Relations

In preferred embodiments, new relations may be defined in terms of RelationshipPrimitives, by combining where- and whereNext-clauses in a self-referencing query. This is illustrated by Query E2.4 in Example E2.2 which retrieves the record set defined by SiblingOrSelf as the set of Child relations of the Parent of the selected context node, akin to navigating nodes in a hierarchical document using XPath expressions. This functionality corresponds to the application of a rule.

### 2.4.2 Recursively Defined Relations

The methods of the present invention further provide the means for retrieving record sets in accordance with recursive relations, such as Ancestor and Descendant, defined as follows: For All x,y,z under consideration, Parent(x, y) AND Ancestor(y, z)→Ancestor(x, z), where Ancestor(x,y)=Parent(x,y), and analogously for Descendant REF—Lecture Notes TU Dresden at iccl.inf.tu-dresden.de website under/w/images/b/b2 and further under/Lecture-12-datalog-introduction.pdf.

Query 2.4.1 recursively retrieves the record set comprising nodes defined by the recursive Ancestor relation with reference to a pre-selected context node (‘cn’), namely by: specifying, in the where-clause, a query pattern to retrieve the Parent as the first Ancestor of cn and, in the rwhereNext-clause, a query pattern to recursively retrieve Parent of Parent of Parent . . . , wherein the templated PredicateExpression is instantiated anew in each cycle with the record returned by the previous cycle. The combination of where-clause and rwhereNext-clause thus implements the recursive definition of the Ancestor relation above in a manner equivalent to the application of a recursive rule.

Query 2.4.1

```
let rpqGTR_anc_opt_alt = {
  find: [″?recordNo″,″?parentRecordNo″,″?level″,″?leaf″,″?uniquePropPath″,
  ″?propKey″],
  in: [″?pRcNoExpr″],
  where: [ // Parent
    {″?recordNo″:″?pRcNoExpr″},
  ],
  rwhereNext: [ // recursive where clause: Parent of Parent of Parent ...
    {″?recordNo″:″(x) => isEQ(x,′_@w.parentRecordNo@_′)″},
  ],
  whereFurther: [
    {″?leaf″:″(x) => Number(x) === 0″}, // exclude leaves
    {″?recordNo″:″(x) => Number(x) > 0″}, // exclude root
    {″?propAttr″:″(x) => x === ′(null)′″} // exclude ′extra′ records
  ]
};
// usage
let qinArgs_Parent_alt = [
  ‘(x) => isEQ(x,′${cn.recordNo}′)‘ // reference context node via template literal
];
let rpqOutp = query(rpqGTR_anc_opt_alt, gtrTb, qinArgs_Parent_alt);
```

In accordance with the preferred execution model of the current invention, implemented in the Interpreter, execution of this query, illustrating several features of the query language of the present invention, proceeds as follows:
1—instantiate the in-clause, by substituting for “?pRcNoExpr” the content of qinArgs_Parent_alt, provided as an arg to the query evaluator—
2—instantiate the where-clause (notably “?pRcNoExpr”) by referencing the instantiated in-clause;
3—execute the where-clause to obtain the Parent of the context node and store in an (‘accumulator’) array;
4—recursively:
   instantiate the rwhereNext-clause by referencing the ‘parent’ record set returned by the preceding where-clause;
   execute the where-clause, now instantiated by referencing the rwhereNext-clause and add this to the accumulator;
   stop when execution of the where-clause returns an empty record set;
5—to the record set available after completion of step 4, apply auxiliary patterns by executing the whereFurther-clause;
6—filter the record set to select items specified in the find-clause replace keys by aliases, as specified by the substring following ‘_AS_’;

Executing this query, for the context node selected above, retrieves the same record set of 10 ancestors returned, without invoking recursion, by Query E2.2, namely: recordNo=[539, 533, 529, 528, 519, 517,378, 375, 154, 148, 1]. While the query patterns in Query E2.2 specify constraints on absolute node paths, encoded in the form of uniquePropPath as well as node level, to retrieve Ancestors non-recursively, the recursive Query 2.4.1 prescribes traversal of nodes by concatenating relative node paths, specified by recordNo and parentRecordNo only.

Descendants (that is: the record set comprising nodes defined by the Descendant relation) of the pre-selected context node (‘cn’) are recursively retrieved by Query 2.4.2, specifying query patterns, in where- and rwhereNext-clauses, to select, respectively: the Child of cn, then recursively Child of Child of Child . . . .

Query 2.4.2

```
let rpqGTR_desc_opt_alt = {
  find: [″?recordNo″,″?parentRecordNo″,″?level″,″?leaf″,″?uniquePropPath″,
″?propKey″],
  in: [″?pRcNoExpr″],
  where: [ // Child
    {″?parentRecordNo″:″?pRcNoExpr″}
  ],
  rwhereNext: [ // recursive where clause: Child of Child of Child ...
    {″?parentRecordNo″:″(x) => isEQ(x,′_@w.recordNo@_′)″},
  ],
  whereFurther: [
    {″?leaf″:″(x) => Number(x) === 0″},
    {″?propAttr″:″(x) => x === ′(null)′″}
  ]
}
// usage
let qinArgs_Child_alt = [
  ‘(x) => isEQ(x,′${cn.recordNo}′)‘
];
let rpqOutp =queryGTR(rpqGTR_desc_opt_alt, gtrTb, qinArgs_Child_alt);
```

Executing this query, for the context node selected above, retrieves a record set of 43 descendants of the context node specified above.

### 3. Implementation & Deployment

In a preferred embodiment wherein the Interpreter is a JavaScript program, the query language of the present invention can be deployed in any environment supporting JavaScript, including but not limited to nodeJS or other run-time environments, or in a web browser.

Local—In one embodiment, the query language of the invention is deployed locally, as part of a JavaScript application, preferably by importing the requisite modules implementing the QueryEvaluator and related functionality.

As-a-Service—In another embodiment, the query language is invoked as a service, by converting the query object to JSON and transmitting it to a server by way of an API request, wherein the server preferably also hosts the data collection of interest; upon query execution, the query output is returned to the local application.

### 3.1 Interactive Query Interface

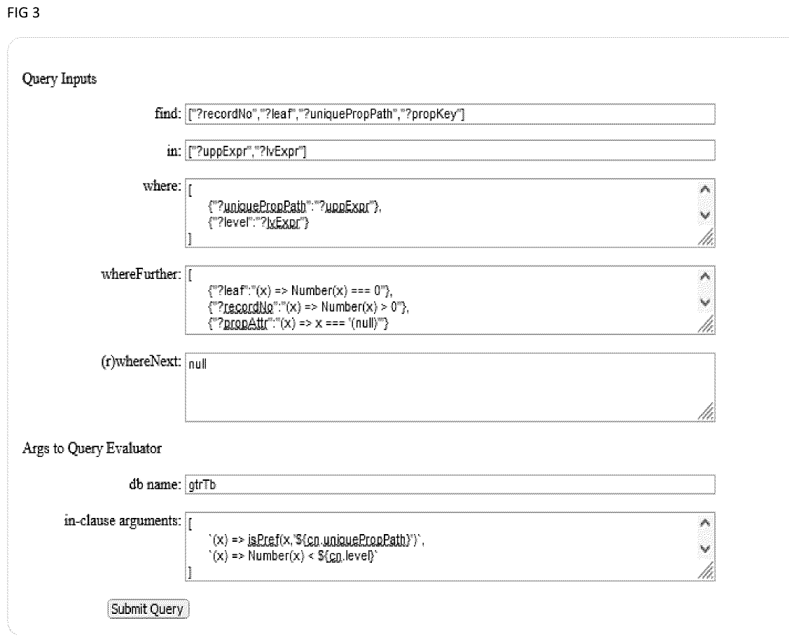

In one embodiment, the query object is interactively created, or modified, and submitted to the QueryEvaluator by way of a web form, as illustrated in FIG. 3 for Query E2.2. Upon submission of the form, JavaScript code within a script block of the HTML mark-up collects data from the form and assembles the query object, preferably by invoking the functionality for dynamic query assembly disclosed in Sect. 1.3, and invokes the QueryEvaluator; query output may be displayed in HTML, preferably in a separate window, or otherwise processed. Similarly, a form also may be implemented as a local client, for example as a Microsoft Windows form.

### Examples

### E.1 Tabular Display of User-Selected Content: Chained Self-Joins

The SQL Query E1.1 of chained self-joins, applied to the (complete) data set of Table 1 (referred to in the query as ‘theTable’) returns the Table E.1.1 of 14 records, below, with columns named in accordance with the aliases specified in the SELECT clause.

Query E1.1 (SQL)

```
SELECT
      a.propVal AS id,
      g.propVal AS GeneSymbol,
      b.propVal AS gSyntax,
      c.propVal AS pSyntax,
      d.propVal AS transcSyntax
FROM theTable a
JOIN theTable b
ON INSTR(b.uniquePropPath,(‘4-’ | | a.parentRecordNo)) > 0
    AND a.propKey = ‘id’ AND b.propKey = ‘gSyntax’
LEFT JOIN theTable c
ON INSTR(c.uniquePropPath,(‘4-’ | | a.parentRecordNo)) > 0
    AND a.propKey = ‘id’ AND c.propKey = ‘pSyntax’ AND INSTR(c.propPath,‘cSyntaxes[0]’) > 0
JOIN theTable d
ON INSTR(d.uniquePropPath,(‘4-’ | | a.parentRecordNo)) > 0
    AND a.propKey = ‘id’ AND d.propKey = ‘transcSyntax’ AND INSTR(d.propPath,‘cSyntaxes[0]’)
> 0
JOIN theTable g
ON INSTR(g.uniquePropPath, (‘4-’ | | a.parentRecordNo)) > 0
    AND a.propKey = ‘id’ AND g.propKey = ‘symbol’ AND INSTR(g.propPath, ‘cSyntaxes[0]’) > 0
```

TABLE E.1.1

| id | GeneSymbol | gSyntax | pSyntax | transcSyntax |
|---|---|---|---|---|
| 153969_6836247147610989546_0_0_196 | MSH2 | chr2: g.47702190_ | NP_000242.1: p.N596* | NM_000251.2: c.1786_ |
| | | 47702191delAA | | 1787delAA |
| 153969_6836247147610989546_0_0_306 | FBXW7 | chr4: g.153245402C > T | NP_001013433.1: p.G479R | NM_001013415.1: |
| | | | | c.1435G > A |
| 153969_6836247147610989546_0_0_313 | TERT | chr5: g.1295250G > A | (null) | NM_198253.2: c.-146C > T |
| 153969_6836247147610989546_0_0_467 | SMO | chr7: g.128845452C > A | NP_005622.1: p.A250D | NM_005631.4: c.749C > A |
| 153969_6836247147610989546_0_0_590 | CDKN2A | chr9: g.21971108C > T | NP_000068.1: p.D84N | NM_000077.4: c.250G > A |
| 153969_6836247147610989546_0_0_638 | TSC1 | chr9: g.135781059_ | NP_000359.1: p.E636Gfs*51 | NM_000368.4: c.1907_ |
| | | 135781060delCT | | 1908delAG |
| 153969_6836247147610989546_0_0_752 | ATM | chr11: g.108175490T > C | NP_000042.3: p.L1862P | NM_000051.3: c.5585T > C |
| 153969_6836247147610989546_0_0_913 | TSC2 | chr16: g.2137930C > T | NP_000539.2: p.Q1686* | NM_000548.3: c.5056C > T |
| 153969_6836247147610989546_0_0_912 | TSC2 | chr16: g.2129303C > T | NP_000539.2: p.A1053V | NM_000548.3: c.3158C > T |
| 153969_6836247147610989546_0_0_1049 | TP53 | chr17: g.7577120C > T | NP_000537.3: p.R273H | NM_000546.5: c.818G > A |
| 153969_6836247147610989546_0_0_1050 | TP53 | chr17: g.7578223_ | NP_000537.3: p.R209Kfs*6 | NM_000546.5: c.626_ |
| | | 7578224delCT | | 627delGA |
| 153969_6836247147610989546_0_0_1078 | NF1 | chr17: g.29527503_ | NP_000258.1: p.E318Kfs*11 | NM_000267.3: c.952_ |
| | | 29527504delGA | | 953delGA |
| 153969_6836247147610989546_0_0_1104 | ERBB2 | chr17: g.37872099C > A | NP_001005862.1: p.L444I | NM_001005862.1: |
| | | | | c.1330C > A |
| 153969_6836247147610989546_0_0_1220 | GNAS | chr20: g.57484420C > T | NP_000507.1: p.R201C | NM_000516.4: c.601C > T |

By the methods of the present invention, the record set in this table is generated by devising a query sequence, also referred to herein as a workflow, that replicates the chained self-join sequence of SQL Query E1.1 (‘SQL’), in this Section above. This workflow comprises an alternating sequence of executing queries and JOIN operations, wherein the function implementing the JOIN accepts a first and a second record set, a PredicateExpression, and an optional string indicating the type of JOIN to be performed, the latter by default having a value of ‘inner’. With the letter notation of the SQL query, the requisite sequence, in one embodiment, comprises a set of simple queries, as follows:

Query E1.2

```
let qGTR_a = {
  find: [“?parentRecordNo”,“?propVal_AS_id”],
  where: [
    {“?propKey”:“(x) => x === ‘id’”}
  ],
  whereFurther: [
    {“?parentRecordNo”:“(x) => Number(x) >= 0”}
  ]
}
let qGTR_b = {
  find: [“?uniquePropPath”,“?propVal_AS_gSyntax”],
  where: [
    {“?propKey”:“(x) => x === ‘gSyntax’”}
  ]
}
let qGTR_c = {
  find: [“?uniquePropPath”,“?propVal_AS_pSyntax”],
  where: [
    {“?propKey”:“(x) => x === ‘pSyntax’”},
    {“?propPath”:“(x) => x.includes(‘cSyntaxes[0]’)”}
  ]
}
let qGTR_d = {
  find: [“?uniquePropPath”,“?propVal_AS_transcSyntax”],
  where: [
    {“?propKey”:“(x) => x === ‘transcSyntax’”},
    {“?propPath”:“(x) => x.includes(‘cSyntaxes[0]’)”}
  ]
}
let qGTR_g = {
  find: [“?uniquePropPath”,“?propVal_AS_GeneSymbol”],
  where: [
    {“?propKey”:“(x) => x === ‘symbol’”},
    {“?propPath”:“(x) => x.includes(‘cSyntaxes[0]’)”}
  ]
}
```

Each of these queries extracts a record set, with propKey constrained to one of the variables of interest, namely those identified in the SELECT clause of the SQL query: id, gSyntax, pSyntax, transcSyntax and symbol.

In the transformation workflow, successive JOINs accumulate the query outputs, as follows:

```
let a = queryGTR(qGTR_a, gtrTb);
let ab = joinOnPredExpr(a, queryGTR(qGTR_b, gtrTb),
  ″(e1,e2) => isPref(′4-′.concat(e1.parentRecordNo),e2.uniquePropPath)″)
let abc = joinOnPredExpr(ab, queryGTR(qGTR_c, gtrTb),
  ″(e1,e2) => isPref(′4-′.concat(e1.parentRecordNo),e2.uniquePropPath)″,″left″)
let abcd = joinOnPredExpr(abc, queryGTR(qGTR_d, gtrTb),
  ″(e1,e2) => isPref(′4-′.concat(e1.parentRecordNo),e2.uniquePropPath)″)
let abcdg = joinOnPredExpr(abcd, queryGTR(qGTR_g, gtrTb),
  ″(e1,e2) => isPref(′4-′.concat(e1.parentRecordNo),e2.uniquePropPath)″)
```

The record set ‘abcdg’ returned by this workflow is an array of 14 objects, wherein each object comprises the desired entries, as follows (showing only the first and last records):

```
[
  {
    parentRecordNo: ‘46402’,
    id: ‘153969_6836247147610989546_0_0_196’,
    uniquePropPath: ‘.0-0.1-5.2-46399.3-46401.4-46402.5-46404.6-46405.7-46406.8-46408.9-
46409’,
    gSyntax: ‘chr2:g.47702190_47702191delAA’,
    pSyntax: ‘NP_000242.1:p.N596*’,
    transcSyntax: ‘NM_000251.2:c.1786_1787delAA’,
    GeneSymbol: ‘MSH2’
  },
...
  {
    parentRecordNo: ‘163330’,
    id: ‘153969_6836247147610989546_0_0_1220’,
    uniquePropPath: ‘.0-0.1-5.2-46399.3-46401.4-163330.5-163332.6-163333.7-163334.8-
163336.9-163337’,
    gSyntax: ‘chr20:g.57484420C>T’,
    pSyntax: ‘NP_000507.1:p.R201C’,
    transcSyntax: ‘NM_000516.4:c.601C>T’,
    GeneSymbol: ‘GNAS’
  }
]
```

This object optionally may be filtered so as to remove the entries at ‘parentRecordNo’ and ‘uniquePropPath’ and to sort the remaining entries by key in a desired order; optionally, it may be transformed to the familiar comma-separated value (‘csv’) format or other formats. To improve execution efficiency, the queries in Query E1.2 comprising a pattern to constrain the value of propPath, are re-cast by placing that pattern into a whereFurther clause, as follows:

Query E1.3

```
qGTR_g = {
  find: [“?uniquePropPath”,“?propVal_AS_pSyntax”],
  where: [
    {“?propKey”:“(x) => x === ‘pSyntax’”}
  ],
  whereFurther: [
    {“?propPath”:“(x) => x.includes(‘cSyntaxes[0]’)”}
  ]
}
```

Programmatic Assembly—In one embodiment, the query sequence Query E1.2, given its structure of chained self-joins, is assembled programmatically by a suitable JavaScript function, wherein the constituent queries preferably are parametric queries that are invoked with the requisite argument provided to the QueryEvaluator, as described in Section 1.2. In a further embodiment, the workflow itself is assembled programmatically by a suitable JavaScript function.

### E.2 Relationship Primitives

Example E.2 illustrates the implementation of RelationshipPrimitives for the Generic Tabular Representation of the HTML source of the National Cancer Institute web page entitled ‘List of Targeted Therapy Drugs Approved for Specific Types of Cancer’, a section of which is shown in Table E.2.1, while also illustrating the use of several query constructs disclosed herein above. While illustrating the implementation of relationship primitives by the methods of the invention, this Example further illustrates the use of parametrized queries, self-referencing queries and named pattern groups.

TABLE E.2.1

| recordNo | parentRcNo | leaf | level | uniquePropPath |
|---|---|---|---|---|
| 533 | 529 | 0 | 11 | .0-0.1-1.2-148.3-154.4-375.5-378.6-517.7-519.8-522.9-528.10-529.11-533 |
| 534 | 533 | 1 | 11 | .0-0.1-1.2-148.3-154.4-375.5-378.6-517.7-519.8-522.9-528.10-529.11-533 |
| 535 | 533 | 0 | 12 | .0-0.1-1.2-148.3-154.4-375.5-378.6-517.7-519.8-522.9-528.10-529.11-533.12-535 |
| 536 | 535 | 1 | 12 | .0-0.1-1.2-148.3-154.4-375.5-378.6-517.7-519.8-522.9-528.10-529.11-533.12-535 |
| 537 | 535 | 0 | 13 | .0-0.1-1.2-148.3-154.4-375.5-378.6-517.7-519.8-522.9-528.10-529.11-533.12-535.13-537 |
| 538 | 537 | 1 | 14 | .0-0.1-1.2-148.3-154.4-375.5-378.6-517.7-519.8-522.9-528.10-529.11-533.12-535.13-537.14-538 |
| 539 | 533 | 0 | 12 | .0-0.1-1.2-148.3-154.4-375.5-378.6-517.7-519.8-522.9-528.10-529.11-533.12-539 |
| 540 | 539 | 1 | 12 | .0-0.1-1.2-148.3-154.4-375.5-378.6-517.7-519.8-522.9-528.10-529.11-533.12-539 |
| 541 | 539 | 0 | 13 | .0-0.1-1.2-148.3-154.4-375.5-378.6-517.7-519.8-522.9-528.10-529.11-533.12-539.13-541 |
| 542 | 541 | 1 | 13 | .0-0.1-1.2-148.3-154.4-375.5-378.6-517.7-519.8-522.9-528.10-529.11-533.12-539.13-541 |
| 543 | 541 | 1 | 13 | .0-0.1-1.2-148.3-154.4-375.5-378.6-517.7-519.8-522.9-528.10-529.11-533.12-539.13-541 |

| propPath | propKey | propVal | propAttr | SourceId | TimeStamp |
|---|---|---|---|---|---|
| html.body.div.div.div.div.div.main.article.div.div | div | (null) | (null) | (null) | 1692100000000 |
| html.body.div.div.div.div.div.main.article.div.div | div.id | (null) | cgvBody | (null) | 1692100000000 |
| html.body.div.div.div.div.div.main.article.div.div.div | div | (null) | (null) | (null) | 1692100000000 |
| html.body.div.div.div.div.div.main.article.div.div.div | div.class | (null) | blog-intr [symbol] | (null) | 1692100000000 |
| html.body.div.div.div.div.div.main.article.div.div.div.p | p | (null) | (null) | (null) | 1692100000000 |
| html.body.div.div.div.div.div.main.article.div.div.div.p.#text | #text | The FDA has app [symbol] | (null) | (null) | 1692100000000 |
| html.body.div.div.div.div.div.main.article.div.div.div | div | (null) | (null) | (null) | 1692100000000 |
| html.body.div.div.div.div.div.main.article.div.div.div | div.class | (null) | accordio [symbol] | (null) | 1692100000000 |
| html.body.div.div.div.div.div.main.article.div.div.div.nav | nav | (null) | (null) | (null) | 1692100000000 |
| html.body.div.div.div.div.div.main.article.div.div.div.nav | nav.class | (null) | on-this-p [symbol] | (null) | 1692100000000 |
| html.body.div.div.div.div.div.main.article.div.div.div.nav | nav.role | (null) | navigatio [symbol] | (null) | 1692100000000 |

[symbol]

indicates data missing or illegible when filed

### E.2.1 Context Node Selection: Self-Referencing Queries

First, select a context node of interest, here by specifying values for the attributes propKey and propAttr.

In a first embodiment, this is achieved by executing, in sequence, Query E2.1.1, to return a record assigned to cnAttr, and Query E2.1.2, to return the record representing the context node. The latter query illustrates the use of a where-clause referencing an external object, namely cnAttr, by way of the expression ${cnAttr.parentRecordNo}; the wild-card ‘*’ in the argument of the find clause, mimicking the familiar notation of the SQL SELECT clause, specifies that all attributes are to be included in the retrieved record; isEQ denotes a convenience function implementing the predicate ‘isEqual’, i.e. isEQ=(x,y)=>x===y.

Query E2.1.1

```
let qGTR_cnAttr = {
  find: [″?*″],
  where: [
    {″?propKey″:”(x) => isEQ(x,′div.class′)”},
    {″?propAttr″:”(x) => isEQ(x,′accordion′)”}
  ]
}
let cnAttr = queryGTR(qGTR_cnAttr,gtrTb);
```

Query E2.1.2

```
let qGTR_cn = {
  find: [″?*″],
  where: [
    {″?recordNo″:‘(x) => isEQ(Number(x),${cnAttr.parentRecordNo})‘}
  ]
}
let cn = queryGTR(qGTR_cn,gtrTb);
```

The records returned by the two queries are shown in Table E2.1.1 and Table E2.1.2, respectively. In one embodiment, a function is provided to execute both queries and return the content node.

TABLE E2.1.1
Context Node Attributes

```
{
  rowid: ‘540’,
  recordNo: ‘539’,
  parentRecordNo: ‘533’,
  leaf: ‘0’,
  level: ‘12’,
  uniquePropPath: ‘.0-0.1-1.2-148.3-154.4-375.5-378.6-517.7-519.8-522.9-528.10-529.11-
533.12-539’,
  propPath: ‘html.body.div.div.div.div.div.main.article.div.div.div’,
  propKey: ‘div’,
  propVal: ‘(null)’,
  propAttr: ‘(null)’,
  SourceId: ‘(null)’,
  TimeStamp: ‘1.6921E+12’.
```

TABLE E2.1.2
Context Node

```
{
  rowid: ‘541’,
  recordNo: ‘540’,
  parentRecordNo: ‘539’,
  leaf: ‘1’,
  level: ‘12’,
  uniquePropPath: ‘.0-0.1-1.2-148.3-154.4-375.5-378.6-517.7-519.8-522.9-528.10-529.11-
533.12-539’,
  propPath: ‘html.body.div.div.div.div.div.main.article.div.div.div’,
  propKey: ‘div.class',
  propVal: ‘(null)’,
  propAttr: ‘accordion’,
  SourceId: ‘(null)’,
  TimeStamp: ‘1.6921E+12’,
  ‘Annotation\r’: ‘descendant\r’
}
```

Self-Referencing Query—in a preferred embodiment, the context node in Table E2.1.2 is retrieved more simply and transparently by executing the single self-referencing Query E2.1.3; this query comprises a whereNext clause that references the record set returned by execution of the preceding where (‘w’) clause, namely by way of the substitution variable (‘subVar’) ‘_@w.parentRecordNo@_’, identified by the delimiters ‘_@’ and ‘@_’. The execution model implemented in a preferred embodiment of the Interpreter processes where-clauses in sequence so that the record set returned by executing the where-clause is available prior for instantiating and processing the whereNext-clause.

Query E2.1.3

```
let qGTR_cnByAttr = {
  find: [“?*”],
  where: [
      {“?propKey”:“(x) => isEQ(x,‘div.class')”},
      {“?propAttr”:“(x) => isEQ(x,‘accordion’)”}
  ],
  whereNext: [
    {“?recordNo”:“(x) => isEQ(Number(x),_@w.parentRecordNo@_)”}
  ]
}
// let cnByAttr = queryGTR(qGTR_cnByAttr,gtrTb,false);
```

### E.2.2 Navigating the Generic Tabular Representation

As a first example, Ancestors to the selected context node are identified by executing the parametrized Query E2.2.1, wherein the where clause comprises (strings specifying) variables ?uppExpr and ?lvExpr that match those in the in clause.

Query E2.2.1

```
let pqGTR = {
  find: [“?recordNo”,“?uniquePropPath”,“?propKey”],
  in: [“?uppExpr”,“?lvExpr”],
  where: [
    {“?uniquePropPath”:“?uppExpr”},
    {“?level”:“?lvExpr”}
  ],
  whereFurther: [
    {“?leaf”:“(x) => Number(x) === 0”}, // exclude leaves
    {“?recordNo”:“(x) => Number(x) > 0”}, // exclude root
    {“?propAttr”:“(x) => x === ‘(null)’”} // exclude ‘extra’ recs
  ]
}
```

Query E2.2.1 also provides a further illustration of the use of a whereFurther-clause; that is, while in one embodiment, the where-clause comprises all patterns, in a preferred embodiment, the where-clause comprises only patterns to be applied to the entire data collection, and the whereFurther clause comprises additional patterns to be applied only to the record set returned by execution of the where-clause. As that record set is smaller than the original data collection, this preferred form of the query reduces the number of operations, and thereby improves execution efficiency.

This query is executed by invoking the function queryGTR with the arguments in the array inClauseArgs_ancestor, as follows:

```
const inClauseArgs_ancestor = [
  ‘(x) => isPref(x,′${cn.uniquePropPath}′)‘, // specify ancestor
  ‘(x) => Number(x) < ${cn.level}‘ // exclude self
];
const qOutp = queryGTR(pqGTR, gtrTb, inClauseArgs_ancestor)
```

As described, query execution proceeds by: first, instantiating the variables in the in-clause by the values specified in the array inClauseArgs_ancestor, wherein context node properties once again are referenced by way of ${ . . . }; next, instantiating the where-clause by referencing the instantiated in-clause.

This produces a record set in the form of an array of 10 objects, with values of recordNo in the set [533, 529, 528, 519, 517, 378, 375, 154, 148, 1], wherein the value of uniquePropPath for each such ancestor satisfies that condition specified in inClauseArg_ancestor, namely that the value of uniquePropPath for the selected context node, namely 1.0-0.1-1.2-148.3-154.4-375.5-378.6-517.7-519.8-522.9-528.10-529.11-533.12-539′ contain the value of uniquePropPath for any ancestor as a prefix (as may be verified by visual inspection). To obtain the Parent set (comprising a single record), select the most immediate Ancestor, by the function expression ‘(x)=>Number(x)=${cn.level}—1’.

Other Relationship Primitives—To obtain the Descendant set, execute Query E2.2.1 with appropriately modified arguments, as follows:

```
const inClauseArgs_desc = [
  ‘(x) => isPref(′${cn.uniquePropPath}′, x)‘, // specify descendant
  ‘(x) => Number(x) > ${cn.level}‘ // exclude self
];
const qOutp = queryGTR(pqGTR, gtrTb, inClauseArgs_desc)
```

To obtain the Child set, select the first Descendant, by the function expression ‘(x)=>Number(x)=${cn.level}+1’.

In similar fashion, queries for any of the relationship primitives may be implemented, without recursion, by specifying appropriate constraints. For example, Query E2.2.2, wherein the principal constraints in the where-clause pattern now reference parentRecordNo and recordNo, returns the PrecedingSibling or FollowingSibling sets, given appropriate in-clause arguments:

Query E2.2.2

```
let qGTR_precORfollwSib_opt = {
  find: [“?recordNo”,“?leaf”,“?uniquePropPath”,“?propKey”],
  in: [“?pRecNoExpr”,“?recNoExpr”],
  where: [
    {“?parentRecordNo”:“?pRecNoExpr”},
    {“?recordNo”:“?recNoExpr”}
  ],
  whereFurther: [
    {“?propAttr”:“(x) => x === ‘(null)’”} // exclude ‘extra’ records
  ]
}
```

To obtain the PrecedingSibling set, execute Query E2.2.2 by invoking the function queryGTR with the arguments in the array inClauseArgs_pSib, as follows:

```
const inClauseArgs_precSib = [
  ‘(x) => x === ′${cn.parentRecordNo}′‘, // same parent
  ‘(x) => Number(x) < ${cn.recordNo}‘
];
//Usage: const qOutp = query(pqGTR, gtrTb, inClauseArgs_ancestor)
```

Analogously, to obtain the FollowingSibling set, execute Query E2.2.2 by invoking the function queryGTR with the arguments in the array inClauseArgs_fSib, as follows:

```
const inClauseArgs_follwSib = [
  ‘(x) => x === ′${cn.parentRecordNo}′‘, // same parent
  ‘(x) => Number(x) > ${cn.recordNo}‘
];
// Usage: const qOutp = query(pqGTR, gtrTb, inClauseArgs_ancestor)
```

Defined Relations: SiblingOrSelf—In a preferred embodiment, the self-referencing Query E2.2.3 retrieves the record set defined by SiblingOrSelf as the set of Child relations of the Parent of the selected context node, akin to navigating nodes in a hierarchical document using XPath expressions. To that end, Query 2.2.3 comprises patterns, in a whereNext-clause, wherein the parametrized Predicate Expressions, by way of the substitution variables ‘_@w.uniquePropPath@_’ and ‘_@w.level@_’ reference the Parent record returned by execution of the preceding where-clause. In this embodiment, Query E2.2.3 references the context node by way of the generic interface provided by the in-clause, rather than by explicit reference using template literals.

Execution of this query, with the context node selected above, produces a record set of two siblings, namely the context node itself, identified by recordNo=539, and the additional sibling identified by recordNo=535.

Query E2.2.3

```
let qGTR_sibOrSelf = {
  find: [″?recordNo″,″?level″,″?leaf″,″?uniquePropPath″,″?propKey″],
  in: [″?uppExpr″,″?lvExpr″],
  where: [ // parent
    {″?uniquePropPath″:″?uppExpr″},
    {″?level″:″?lvExpr″},
    {″?propAttr″:″(x) => x === ′(null)′″} // exclude ′extra′ records
  ],
  whereNext: [ // child relations of parent
      {″?uniquePropPath″:″(x) => isPref(′_@w.uniquePropPath@_′,x)″},
      {″?level″:″(x) => Number(x) === _@w.level@_+1″},
      {″?leaf″:″(x) => Number(x) === 0″} // exclude ′extra′ records
  ]
}
// usage
// args object defining Parent node by referencing context node object, ‘cn’
const qinArgs_Parent = [
  ‘(x) => isPref(x,′${cn.uniquePropPath}′)‘, // ancestor
  ‘(x) => Number(x) === ${cn.level} − 1‘ // parent
];
// qOutp = queryGTR(qGTR_sibOrSelf, gtrTb, qinArgs_Parent);
```

The specific methods, procedures, and examples described herein are representative of preferred embodiments and are exemplary and not intended as limitations on the scope of the invention. Other objects, aspects, and embodiments will occur to those skilled in the art upon consideration of this specification, and are encompassed within the spirit of the invention as defined by the scope of the claims. It will be readily apparent to one skilled in the art that varying substitutions and modifications may be made to the invention disclosed herein without departing from the scope and spirit of the invention. The invention illustratively described herein suitably may be practiced in the absence of any element or elements, or limitation or limitations, which is not specifically disclosed herein as essential. The methods and processes illustratively described herein suitably may be practiced in differing orders of steps, and that they are not necessarily restricted to the orders of steps indicated herein or in the claims. Under no circumstances may the patent be interpreted to be limited to the specific examples or embodiments or methods specifically disclosed herein. Under no circumstances may the patent be interpreted to be limited by any statement made by any Examiner or any other official or employee of the Patent and Trademark Office unless such statement is specifically and without qualification or reservation expressly adopted in a responsive writing by Applicants.

The invention has been described broadly and generically herein. Each of the narrower species and subgeneric groupings falling within the generic disclosure also form part of the invention. The terms and expressions that have been employed are used as terms of description and not of limitation, and there is no intent in the use of such terms and expressions to exclude any equivalent of the features shown and described or portions thereof, but it is recognized that various modifications are possible within the scope of the invention as claimed. Thus, it will be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

What is claimed is:

1. A method for querying by pattern matching a relational data store comprising a collection of records having a preset number of attributes, representing the content of a hierarchically structured or an unstructured primary data source, wherein the representation also encodes the structure of the primary data source in the form of relative or absolute node paths, the method comprising:
providing at least one query comprising at least a find- and a where-clause, wherein the where-clause comprises one or more query patterns expressing constraints, and the find-clause specifies a subset of attributes optionally including aliases thereof;
executing the query by:
applying predicates in the one or more query patterns to identify, for each pattern, a subset of records matching, or not matching, the pattern; for the case of two or more patterns, forming the intersection of the two or more subsets of records so obtained;
in accordance with the find-clause, selecting specified attributes and applying the aliases, if any; and
thereby identifying the subset of records satisfying the constraints expressed in the query patterns.

2. The method of claim 1 wherein the query is executed by a query Interpreter, comprising a QueryEvaluator, and the query is an object in the language of the query Interpreter.

3. The method of claim 2 wherein the query Interpreter is a JavaScript program, and the object is a JavaScript object.

4. The method of claim 1 wherein each query pattern is in the form of a key-value pair, wherein the key is a string identifying an attribute and the value is a PredicateExpression.

5. The method of claim 4 wherein the PredicateExpression represents a negation, or the conjunction or disjunction of two or more predicates.

6. The method of claim 1 wherein the query also has an in-clause comprising variables that match variables in the query patterns of the where-clause.

7. The method of claim 6 wherein the in-clause comprises a named pattern group for instantiating query patterns in the where-clause.

8. The method of claim 6 wherein the variables of the in-clause are instantiated by additional arguments provided to a QueryEvaluator.

9. The method of claim 1 wherein the query also has a whereFurther-clause comprising query patterns to be applied to the record subset returned by execution of the where-clause.

10. The method of claim 1 wherein a whereNext-clause comprises query patterns referencing the record subset returned by execution of the where-clause.

11. The method of claim 1 wherein the query also has a recursive whereNext-clause comprising query patterns referencing, in a first cycle of a recursive query execution, the record subset returned by execution of the where-clause, and in subsequent cycles the record subset returned by execution of a previous instance of the recursive whereNext-clause.

12. The method of claim 1 wherein the query also has a method-clause comprising a key-value pairs wherein the key references a preceding that is a where-, a whereNext-, a recursive whereNext- or a whereFurther-clause and the value is a PredicateExpression for aggregating or otherwise transforming record subsets returned by execution of the referenced preceding where-, whereNext-, recursive whereNext- or whereFurther-clause.

13. The method of claim 4 wherein, for the case of executing two or more queries directed to the collection of records in the data store, a function implementing a join operation is provided for combining the corresponding two or more record subsets on a specified PredicateExpression.

14. The method of claim 13 comprising an alternating sequence of queries and joins for executing a group of chained self-joins.

15. The method of claim 2 wherein the object is programmatically formed, transformed or instantiated.

16. The method of claim 2 wherein the object is interactively assembled and submitted for execution using a graphical user interface.

17. The method of claim 1 comprising at least one query for identifying relationship primitives.

18. The method of claim 1 comprising at least one query for aggregating selected data items for a tabular display.

19. A method for querying by pattern matching a relational tabular data collection, having a preset number of named attributes, the method comprising:
providing a query comprising at least a find- and a where-clause, wherein the where-clause comprises one or more query patterns expressing constraints, and the find-clause specifies a subset of attributes optionally including aliases thereof;
executing the query by;
applying predicates in the one or more query patterns to identify, for each pattern, a subset of records matching, or not matching, the pattern;
for the case of two or more patterns, forming the intersection of the two or more subsets of records so obtained;
in accordance with the find-clause, selecting a subset of attributes, as specified, and applying aliases, if any; and
and thereby identifying the subset of records satisfying the constraints expressed in the query patterns.

20. The method of claim 19 wherein the query optionally comprises one or more of a clause which is an in-, whereNext-, or a recursive whereNext-, wherefurther- or a method clause.
